(19) United States
(12) Patent Application Publication
(10) Pub. No.: US 2009/0232590 A1
(43) Pub. Date: Sep. 17, 2009

(54) JOINT FOR A MOTOR VEHICLE

(76) Inventors: Metin Ersoy, Walluf (DE); Martin Rechtien, Neuenkirchen-Vörden (DE); Joachim Spratte, Osnabrück (DE); Frank Budde, Steinfeld-Mühlen (DE); Armin Müller, Rahden (DE)

Correspondence Address: MCGLEW & TUTTLE, PC, P.O. BOX 9227, SCARBOROUGH STATION, SCARBOROUGH, NY, 10510-9227, US

(21) Appl. No.: 11/909,132

(22) PCT Filed: Mar. 22, 2005
(86) PCT No.: PCT/DE05/00526

§ 371 Date: Sep. 19, 2007

(51) Int. Cl. F16C 11/06

(52) U.S. Cl. 403/135

(57) ABSTRACT

A joint for a motor vehicle is provided with a housing (5), a bearing shell (4) arranged in the housing (5), a bearing journal (3), which has a bearing area (1) and a pivot area (2) and which is mounted pivotably and/or rotatably in the bearing shell (4) with the bearing area (1). The joint has at least one tensioning device (33), which is arranged in the housing 5, is designed as a solid body and by which a mechanical stress exerted by the bearing shell 4 on the bearing area 1 can be changed. The bearing shell 4 is springy at least in some areas and is deformable by the tensioning means 33 in a springy manner.

### CROSS REFERENCE TO RELATED APPLICATIONS

This application is a United States National Phase application of International Application PCT/DE2005/000526 filed Mar. 22, 2005, the entire contents of which are incorporated herein by reference.

### FIELD OF THE INVENTION

The present invention pertains to a joint for a motor vehicle, with a housing, a bearing shell arranged in the housing, a bearing journal, which has a bearing area and a pivot area, and which is mounted pivotably and/or rotatably with the bearing area in the bearing shell, and at least one tensioning means, which is arranged in the housing, is designed as a solid body and by which a mechanical stress exerted by the bearing shell on the bearing area can be changed.

### BACKGROUND OF THE INVENTION

Joints, especially ball and socket joints, require a certain torque to move the bearing area or the joint ball. A typical torque is, for example, approx. 2 Nm and is intentionally generated by press fit (oversize) of the ball in the ball shell, because an unacceptably great clearance would otherwise develop already after a slight wear or in case of tolerance deviations. However, wishes to lower the torque to below 1 Nm to improve driving smoothness were expressed most recently. However, it is desirable, on the other hand, that the torque increases with increasing wheel frequency in order to absorb wheel vibrations before these are transmitted to the steering or to the chassis. This wish has hitherto been met by using synthetic greases and PUR bearing shells, because the torque increases passively with increasing frequency as a result. However, the effect is only marginal (an up to 3-fold increase in torque can be obtained) and is not always reproducible.

DE 102 45 983 A1 discloses a ball and socket joint with a housing, two bearing shell elements arranged in the housing, a joint body, which has a pivot and a joint ball and is seated with its joint ball between the two bearing shell elements, and with a housing bottom, which is arranged on the side of the housing facing away from the pivot. An adjustable tensioning means, by means of which the prestress, with which the joint body is clamped between the bearing shell elements, can be changed, is arranged between a first of the two bearing shell elements and the housing bottom. The tensioning means may have piezoelectric or hydraulic elements, for example, a hydraulic piston, to change the mechanical prestress.

However, the prestress cannot be set very finely in the case of such a ball and socket joint, because even motions in the range of one hundredths of one mm lead to very great changes in torque. Furthermore, a radial clearance, which is possibly present, is not compensated. A sliding bearing is also necessary for at least one bearing shell element to enable this element to move towards and away from the other bearing shell element, which imposes high requirements on the accuracy of manufacture.

DE 37 40 442 A1 discloses a ball and socket joint with a housing, an elastic bearing shell arranged in the housing, a joint pivot, which has a pivot and a joint ball, and which is seated with its joint ball in the bearing shell, and with a cover, which closes an opening of the housing, which said opening faces away from the bearing journal. One or more chambers, which are filled with a flowable medium and are connected to a valve means arranged downstream of a pressurized medium source, so that axial and radial adjustability of the joint ball can be achieved, are formed in the bearing shell. Furthermore, the overturning moment and the torque can be set.

Such a bearing shell must be manufactured as a hollow shell and consequently with a relatively thin wall, and there is a risk that the wear regularly occurring in bearing shells leads to a crack or hole in the wall of the bearing shell. The flowable medium may run out in case of damage to the pressurized medium circulation, which may lead to a great clearance of the bearing journal in the housing and even to the ball and socket joint becoming unfit for use.

### SUMMARY OF THE INVENTION

The object of the present invention is to perfect a joint of the type mentioned in the introduction such that the torque can be set more finely.

The joint according to the present invention for a motor vehicle has a housing, a bearing shell arranged in the housing, a bearing journal (pivot pin), which is provided with a bearing area (ball) and a pivot area, and which is mounted pivotably and/or rotatably with the bearing area in the bearing shell, and at least one tensioning means or tensioning element or actuator, which is arranged in the housing and by which a mechanical stress exerted by the bearing shell on the bearing area can be changed, wherein the bearing shell is springy at least in some areas and can be deformed by the tensioning means in a springy manner.

It is possible with the joint according to the present invention to deform the bearing shell consisting especially of plastic by means of the tensioning means, which leads to a change in the stress exerted by the bearing shell on the joint area. Finer adjustability of the torque is achieved as a result, because work performed by the tensioning means on the bearing shell is transformed into a deformation of the bearing shell and is thus available for affecting the torque in a weakened or absorbed form only. For example, polyoxymethylene (POM), polyether ether ketone (PEEK), polyurethane (PUR), polyamide (PA) or a combination of these materials may be used as the material for the bearing shell.

Furthermore, a sliding bearing for a separate bearing shell part of a multipart bearing shell may be eliminated, which simplifies the construction of the joint according to the present invention. It is also possible to use one-part bearing shells, as a result of which the effort needed for manufacturing and mounting the joint can be reduced. Since the tensioning means is designed as a solid body, the bearing shell may consist of solid material, so that the drawbacks associated with a bearing shell filled with hydraulic fluid can be avoided. In particular, hollow design of the bearing shell can be eliminated if the tensioning means designed as a solid body is embedded in the bearing shell. Damage to the bearing shell thus does not lead to a liquid pressurized medium running out. Functionally correct operation of the joint is still possible, at least temporarily, even in case of a hole or crack in the bearing shell.

The joint according to the present invention is arranged, for example, in a wheel suspension of a motor vehicle and may be designed as a ball and socket joint, so that a joint ball is preferably formed by the bearing area. If a one-part bearing shell is used, this is provided, for example, with a spherical bearing surface, which is in contact with the joint ball and on which lies at least one great circle, which extends completely within the bearing shell and especially does not form an edge thereof. This great circle may also be a great circle on the joint ball and have the diameter thereof. Furthermore, the joint according to the present invention may be equipped with an angle sensor system, which is preferably integrated within the joint and by which a twisting and/or pivoting of the bearing journal in relation to the housing can be detected.

The tensioning means may be made in one piece with the bearing shell and especially integrated in the bearing shell. Piezoelectric fibers, which are embedded in the material of the bearing shell, are especially suitable for use as tensioning means for such a solution. The bearing shell may be made of a composite material for this purpose, for example, a plastic with piezoceramic fibers or carbon nanotubes, which are embedded therein and form the tensioning means. By applying an electric voltage to the bearing shell, a change in the position of the piezoceramic fibers can be achieved, so that the bearing shell can be deformed and the stress exerted by the bearing shell on the bearing area can be changed. As an alternative, the tensioning means may, however, also be separated from the bearing shell and especially arranged outside same. The tensioning means now acts preferably on a first outer surface area of the bearing shell and may be arranged, for example, between the bearing shell and the housing.

In addition or as an alternative to the use of a piezoelectric material and/or the use of carbon nanotubes, it is also possible to use electrostrictive and/or magnetostrictive materials for the tensioning means or the actuator.

If the first outer surface area lies on a plane that extends at right angles to the longitudinal axis of the joint, this is sensitive to external axial forces acting on the joint area, because the tensioning forces exerted by the bearing shell on the joint area also act against this external force. If this external force reaches or exceeds a certain value, the tensioning action of a bearing shell part may even be abolished, especially when the bearing shell has a two-part design. The first outer surface area therefore preferably extends obliquely in relation to the longitudinal axis of the joint and forms an angle greater than 0 and smaller than 90 with this. The outer surface area is especially truncated cone-shaped, and its axis of symmetry preferably coincides with the longitudinal axis of the joint. Furthermore, the tensioning means may have an oblique, for example, truncated cone-shaped surface area and be in contact with or act on the first outer surface area via this.

It proved to be advantageous if the bearing shell is provided with a second oblique, for example, truncated cone-shaped outer surface area, wherein the housing has an inner wall with an oblique, for example, truncated cone-shaped inner wall area, with which the second outer surface area is in contact. “Oblique” means in this connection that the surface in question, for example, the second outer surface area, forms an angle greater than 0 and smaller than 90 with the longitudinal axis of the joint. Furthermore, the axes of symmetry of the second outer surface area and of the oblique or truncated cone-shaped inner wall area preferably coincide with the longitudinal axis of the joint. The two oblique or truncated cone-shaped outer surface areas taper especially with increasing distance from each other. The bearing area is preferably located at least partially between the two outer surface areas, and, in particular, each of the two truncated cone-shaped outer surface areas enclose a circular area each at the site of its smallest diameter, and the bearing area is arranged at least partially between these two circular surfaces. In case of a one-part design of the bearing shell, the bearing shell may have between the two truncated cone-shaped outer surface areas a cylindrical outer surface area, in which the bearing area is arranged.

The tensioning means may be able to be displaced, extended and/or shortened, so that the deformation of the bearing shell, which leads to a change of the mechanical stress exerted by the bearing shell on the bearing area, is brought about by the change in the position or the external dimensions of the tensioning means. For example, the tensioning means consists of a piezoelectric material, to which an electric voltage can be applied, which leads to a change in the length of the tensioning means and hence to a deformation of the bearing shell. However, such a piezoelectric tensioning means must be readjusted depending on the state of wear of the bearing shell, which is disadvantageous in case of continuous operation of the joint. The tensioning means is therefore preferably a body mounted displaceably in the housing, especially a piston, which can be displaced, for example, by a hydraulic adjusting device. This hydraulic adjusting device has especially a hydraulic fluid and may be arranged outside the housing, but it is preferably integrated, at least partially or even completely, in the housing. Furthermore, a sealing ring may be provided, which seals the outer jacket surface of the piston against the inner wall of the housing.

The hydraulic adjusting device may be provided with a compensating tank, which is filled especially with hydraulic fluid and is used, for example, to compensate losses due to leakage and/or to compensate temperature-dependent variations in the volume of the hydraulic fluid in the hydraulic adjusting device. This compensating tank may also be integrated in the housing and is closed especially with an elastic element or with an elastic cover.

Displacement of the body or piston by means of the preferred hydraulic adjusting device has the advantage that wear of the bearing shell as well as an undesirable great clearance of the bearing journal in the bearing shell, which may possibly result herefrom, can be compensated. Furthermore, a predetermined working torque can be set for the bearing journal by means of the hydraulic adjusting device and it can be maintained or adjusted even in case of wear of the bearing shell. Thus, absence of clearance of the joint can be maintained even in case of wear of the bearing shell.

In addition, a force sensor and/or pressure sensor may be provided in the housing, so that regulation of the hydraulic adjusting device, for example, for adjusting the working torque, can be achieved. The pressure sensor is preferably integrated within the hydraulic circuit, whereas the force sensor may be located between the bearing shell and the joint housing.

The combination of a displaceable body or piston with a hydraulic adjusting device has, furthermore, the advantage that leakage in the hydraulic circuit does not lead, as a rule, to an immediate damage to the bearing shell, so that the joint remains able to function at least temporarily even in case of loss of hydraulic fluid and behaves like a conventional, passive joint (fail-safe property of the joint according to the present invention).

An elastic membrane, via which the hydraulic adjusting device acts on the piston, may be provided between the piston and the housing. The membrane preferably extends on the side of the piston facing away from the bearing shell and is fixed especially sealingly to the housing, so that a sealing ring, which seals the outer jacket surface of the piston against the inner wall of the housing, can be eliminated.

The hydraulic adjusting device may have a hydraulic fluid or one or more hydraulic paths or lines, which are provided especially with one or more valves, for example, nonreturn valves and/or solenoid valves. However, the hydraulic adjusting device preferably has a rheological, for example, electrorheological or magnetorheological hydraulic fluid as the hydraulic fluid, and an especially variable electric or magnetic field passes through at least one hydraulic line. It is thus possible to use the hydraulic line through which the electric or magnetic field flows as a valve, the viscosity of the hydraulic fluid being controlled as a function of the electric or magnetic field. Such a valve is also called rheo valve.

The hydraulic adjusting device may have a hydraulic pump, which is preferably arranged in the housing and may be designed, for example, as a piezo membrane pump. However, it is also possible to provide the hydraulic pump outside the housing.

In addition or as an alternative, the hydraulic adjusting device may have an electric motor arranged at or in the housing as well as a primary piston, which is arranged in a hydraulic chamber and which is displaceable by the electric motor. This electric motor, which is designed especially as a stepping motor, can linearly adjust the primary piston via a gear mechanism and thus control the pressure in the hydraulic chamber for adjusting the piston or the tensioning means. The electric motor can thus be designed as a linear actuator, by which, for example, a threaded spindle can be rotated, which is either displaced linearly itself due to the rotation or which linearly displaces an element seated on the threaded spindle, for example, a nut.

The present invention will be described below on the basis of preferred embodiments with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of a ball and socket joint according to the present invention, in which four embodiments are schematically shown;

FIG. 2 is a sectional view through a ball and socket joint according to a fifth embodiment of the present invention;

FIG. 3 is a sectional view through a ball and socket joint according to a sixth embodiment of the present invention;

FIG. 4 is another sectional view of the embodiment according to FIG. 3;

FIG. 5 is a schematic view of the hydraulic adjusting device of the embodiment according to FIG. 3;

FIG. 6 is a sectional view through a seventh embodiment of the joint according to the present invention;

FIG. 7 is another sectional view of the embodiment according to FIG. 6;

FIG. 8 is a first modification of the joint according to FIG. 3; and

FIG. 9 is a second modification of the joint according to FIG. 3.

### DESCRIPTION OF THE PREFERRED EMBODIMENTS

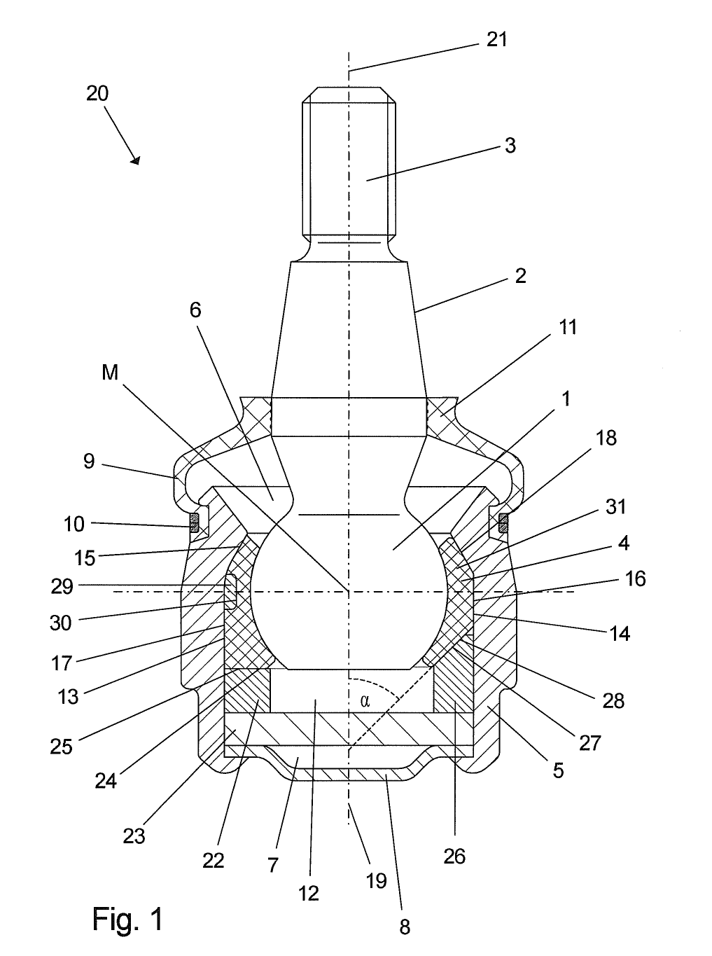

Referring to the drawings in particular, FIG. 1 shows a sectional view through a joint according to the present invention, where four embodiments are shown at the same time and the joint is designed as a ball and socket joint. A bearing journal or ball pivot 3 having a joint ball 1 and a pivot area 2 is mounted rotatably and pivotably with the joint ball or bearing area 1 in a bearing shell 4 of one-part design. The bearing shell 4 is seated in a housing 5, which has an opening 6, through which the ball pivot 3 extends. The housing 5 has an opening 7, which is located opposite the opening 6 and is closed by a cover 8. A sealing bellows 9, whose end 11 facing the opening 6 is sealingly in contact with the pivot area 2, is fixed to the housing 5 in the area of the opening 6 via straining rings 10. A recess 12, which is limited by an inner wall 13 of the housing 5, is provided in the housing 5. The inner wall 13 has a cylindrical inner wall area 14 and a tapering, especially conical inner wall area 15, which adjoins the inner wall area 14. The inner wall area 15 tapers with decreasing distance from the opening 6. The bearing shell 4 is in contact by its outer circumferential surface 16 with the two inner wall areas 14 and 15, so that the bearing shell 4 has a cylindrical outer circumferential area 17, which is in contact with the inner wall area 14, and a tapering, especially conical outer circumferential area 18, which is in contact with the inner wall area 15. The outer circumferential surface area 18 tapers with decreasing distance from the opening 6. The longitudinal axis 19 of the ball and socket joint, designated by 20 as a whole, coincides with the longitudinal axis 21 of the ball pivot 3 in the undeflected state of the said ball pivot 3.

According to a first embodiment of the present invention, a preferably ring-shaped tensioning means 22 is arranged between the bearing shell 4 and the cover 8 via the intermediary of a thrust ring 23. The tensioning means 22 is in contact by a surface area 24 with an outer surface area 25 of the bearing shell 4, the thrust ring 23 being arranged between the tensioning means 22 and the cover 8. The tensioning means 22 is designed here, for example, as an electrically actuated, piezoelectric actuator, which can deform the bearing shell 4 in parallel to the longitudinal axis 19 due to a change in length. The mechanical stress exerted by the bearing shell 4 on the joint ball 1 is changed as a result, so that the torque necessary for pivoting the ball pivot 3 can be set by means of a change in the length of the tensioning element or by means of a change in the electric voltage present on the said tensioning element. The surface area 24 and the outer surface area 25 extend at right angles to the longitudinal axis 19 and are designed especially as annular surfaces.

According to a second embodiment, a preferably ring-shaped tensioning means 26, which is arranged between the thrust ring 23 and the bearing shell 4 and is in contact by a surface area 27 with an outer surface area 28 of the bearing shell 4, is provided instead of the tensioning means 22. The surface area 27 and the outer surface area 28 are conical or truncated cone-shaped and form an angle α with 0°<α<90° with the longitudinal axis 19 in the extension. Due to the oblique or conical design of the two surfaces 27 and 28, more effective transmission of forces is achieved especially towards the center M of the ball 1. The angle α is preferably 30° here, so that the opening angle of the cone is 60°. According to an alternative, the angle α equals, however, e.g., 60°. The tensioning means 26 may also be designed as a piezoelectric actuator, which can be controlled by means of an electric voltage, can deform the bearing shell in parallel to the longitudinal axis 19 due to a change in length and thus change the mechanical stress exerted by the bearing shell 4 on the joint ball 1. The second embodiment is especially an alternative to the first embodiment.

According to a third embodiment, a tensioning means 29, which is arranged in the radial direction between the bearing shell 4 and the inner wall 13 of the housing 5, is provided in addition or as an alternative to the tensioning means 22. The tensioning means 29 is seated in a recess 30 of the bearing shell 4, but may also be arranged, as an alternative, in a recess formed in the inner wall 13. It is possible by means of the tensioning means 29 to build up a stress acting on the joint ball 1 primarily in the radial direction, “radial direction” being defined here as a direction that extends at right angles to the longitudinal axis 19 and preferably intersects the center M of the joint ball 1. The tensioning means 29 may be designed as a piezoelectric actuator, which can be controlled by means of an electric voltage, can deform the bearing shell 4 in the radial direction by a change in length and can thus change the mechanical stress exerted by the bearing shell 4 on the joint ball 1.

According to a fourth embodiment, the bearing shell may be manufactured, in addition or as an alternative to the previous embodiments, completely or at least in some areas, of an electrically deformable composite 31, which consists, for example, of a plastic with piezoceramic fibers or carbon nanotubes, which are embedded therein and form a tensioning means. By applying an electric voltage to the bearing shell 4, deformation or a change in the volume of the bearing shell can be brought about, which leads to a change in the mechanical stress exerted by the bearing shell 4 on the joint ball 1. The bearing shell 4 itself thus forms an actuator.

The effect on the torque is controlled actively in the first four embodiments, and an actuator, which can be actuated especially electrically, is used as the tensioning means. A force is exerted on the bearing shell 4 and hence on the joint ball 1 due to a change in the length or an expansion of the actuator, as a result of which the momentum of the body of the ball and socket joint 20 can be increased or decreased. The actuator consists, for example, of a piezoceramic, plastic or, for example, an electroactive polymer, carbon compounds, for example, carbon nanotubes or a composite, which is composed, for example, of a combination of the above-mentioned materials.

Since the torques of the ball and socket joint 20 can be varied actively by means of the one or more tensioning means, undesired vibrations, which are generated at the wheel of a motor vehicle in certain driving situations, can be absorbed in the ball and socket joint 20. Thus, these vibrations enter the interior space of the vehicle in an absorbed form at most. Furthermore, it is possible to compensate the wear of the ball and socket joint 20, which occurs over the lifetime of the ball and socket joint and may lead to free clearance and consequently to noise.

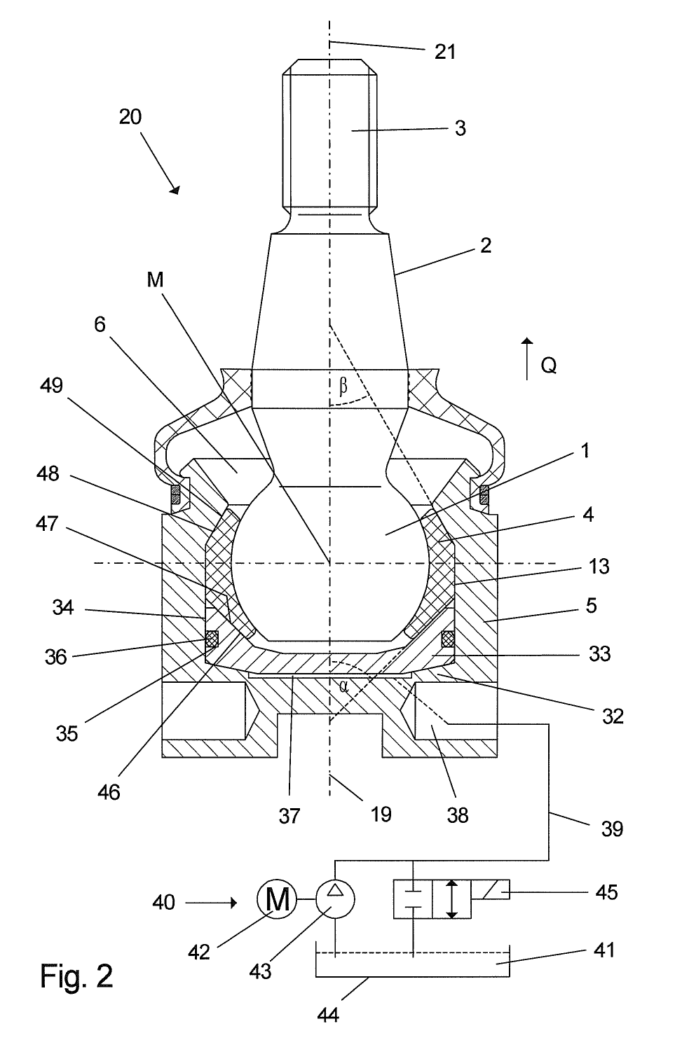

FIG. 2 shows a fifth embodiment of the joint according to the present invention, in which features identical or similar to those in the previous embodiments are designated by the same reference numbers as in the previous embodiments. On the side located opposite the opening 6, the housing 5 is closed by a bottom 32, which is made in one piece with the housing 5 here. A tensioning means 33, which is designed as a piston, which is displaceable in parallel to the longitudinal axis 19 and whose outer circumferential surface 34 is guided displaceably at the inner wall 13 of the housing 5, is provided between the bottom 32 and the bearing shell 4. An annular groove 35, in which a sealing ring 36, which seals the piston 33 against the inner wall 13, is seated in the outer circumferential surface 34. A hydraulic chamber 37, which is connected to a hydraulic adjusting device 40 arranged outside the housing 5 via a connection 38 and a hydraulic line 39, is formed between the piston 33 and the bottom 32. The hydraulic line 39 and the hydraulic adjusting device 40 are shown only schematically.

A hydraulic fluid 41 can be introduced into or drawn off from the hydraulic chamber 37 via the hydraulic adjusting device 40, as a result of which the piston 33 can be moved towards or away from the joint ball 1 along the longitudinal axis 19. The bearing shell 4 can be deformed hereby, which leads to a change in the mechanical stress exerted by the bearing shell 4 on the joint ball 1. A change in the torque of the ball and socket joint can thus be achieved via the hydraulic adjusting device 40.

The hydraulic adjusting device 40 has a hydraulic pump 43, which is driven by a motor 42 and which is in connection with the hydraulic line 39, on the one hand, and with a compensating tank 44 filled with the hydraulic fluid 41, on the other hand. Furthermore, a valve 45 is provided between the compensating tank 44 and the hydraulic line 39.

The piston 33 has a truncated cone-shaped surface area 46, which is in contact with a likewise truncated cone-shaped outer surface area 47 of the bearing shell 4. The truncated cone-shaped surface areas 46 and 47 form an angle α with 0°<α<90° with the longitudinal axis 19 in the extension, and an angle α=30° has proved to be especially suitable. However, according to an alternative, the angle α equals, for example, 60°. Opposite the surface area 47, the bearing shell 4 has a truncated cone-shaped outer surface area 48, which is in contact with a likewise truncated cone-shaped inner wall area 49 of the housing 5. The two truncated cone-shaped areas 48 and 49 form an angle β with 0°≦β≦90° with the longitudinal axis 19 in the extension, and an angle of β=30° has proved to be especially suitable. However, according to an alternative, the angle β equals, for example, 60°. The joint ball 1 or its center M is arranged between the two outer surface areas 47 and 48, the outer surface area 47 and the surface area 46 being aligned such that these two areas 47, 46 taper with increasing distance from the opening 6. By contrast, the outer surface area 48 and the inner wall area 49 are aligned such that these two areas 48, 49 taper with decreasing distance from the opening 6.

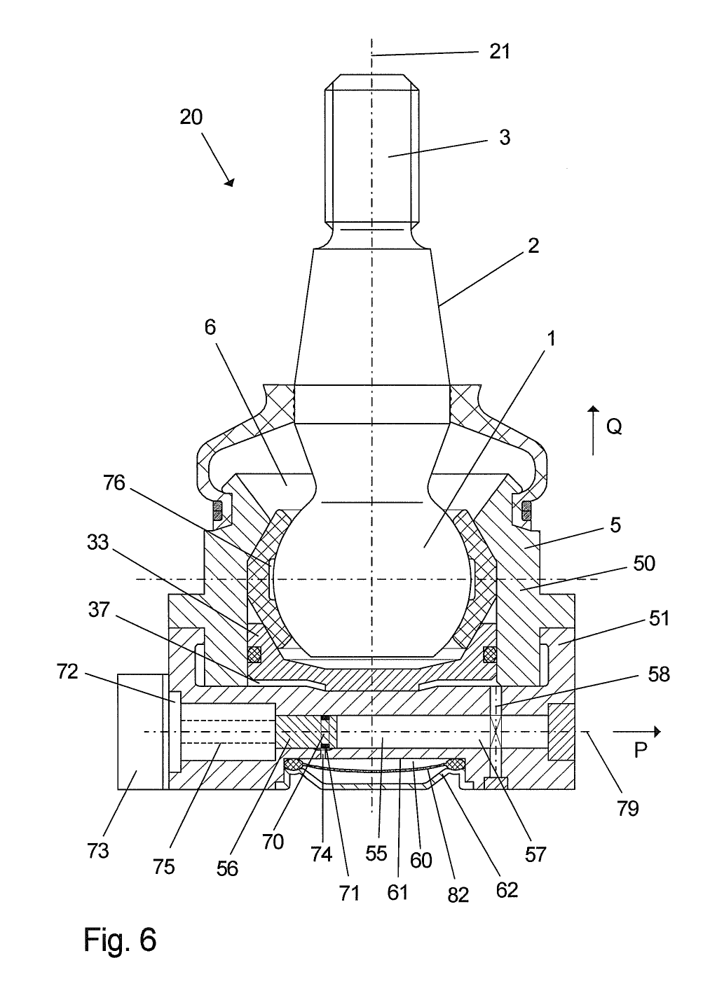

The bearing shell 4, which is designed, on the whole, as a one-part bearing shell, thus has two conical outer contours in the areas 47 and 48. Furthermore, the housing inner wall 13 is made conical in area 49 towards the opening 6. The piston 33 is also conical on its outer surface facing the bearing shell 4 in area 46 or has an inner cone there, and all these conical surfaces 46, 47, 48, 49 preferably having, in terms of value, an equal slope angle α and β, respectively, in relation to the longitudinal axis 19. The drawbacks of the two-part bearing shell in a completely cylindrical housing inner surface are eliminated with this arrangement. Due to the cones (46, 47, 48, 49) preferably equaling approx. 60°, the ball 1 is tensioned by the bearing shell 4 uniformly with equal forces from top and from bottom and a radial clearance that may possibly be present is eliminated. The tensioning force is reinforced by the wedge effect, and a correspondingly increased tensioning stroke can be better controlled. In addition, the system becomes considerably more insensitive to external axial forces. A clearance 76 (see FIG. 6) on the equatorial area of the bearing shell inner surface can enhance this effect, because the tensioning forces now act essentially only towards the center of the ball, especially along the approx. 30° upper and lower degrees of latitude.

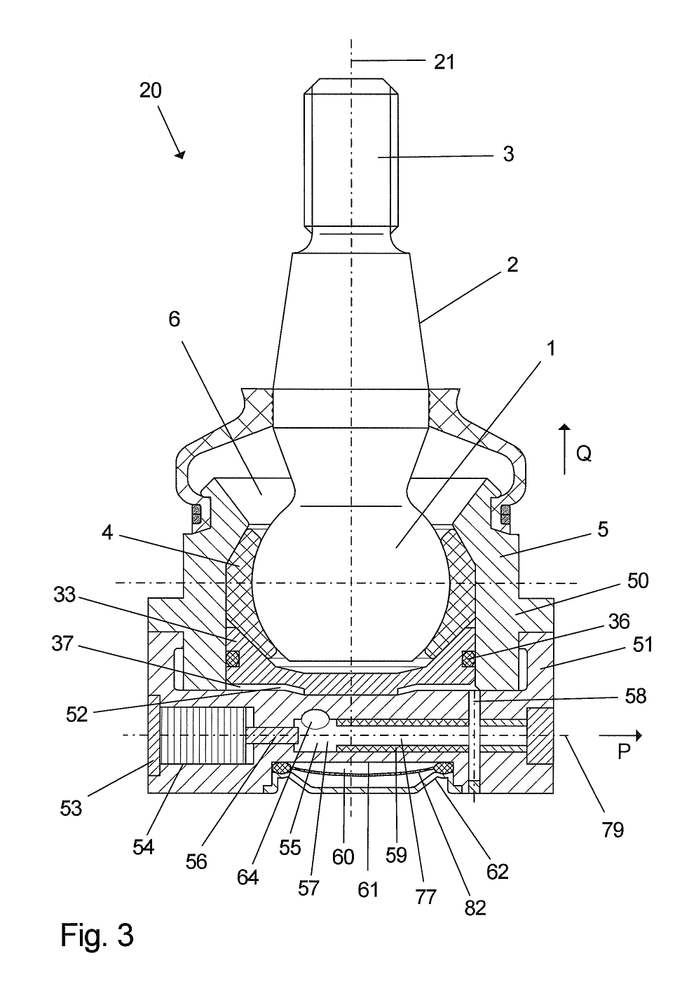

FIG. 3 shows a sixth embodiment of the joint according to the present invention, which is a modification of the fifth embodiment, so that identical or similar features are designated by the same reference numbers as in the fifth embodiment. Contrary to the fifth embodiment, the hydraulic adjusting device is integrated in the sixth embodiment in the joint housing 5, which has a two-part design here and has an upper housing part 50 as well as a lower housing part 51, which is fastened to the upper housing part 50. The lower housing part 51 closes an opening 52 of the upper housing part 50, which said opening is located opposite the opening 6, and thus forms a housing bottom. The hydraulic adjusting device cooperating with the piston 33 and the hydraulic chamber 37 is arranged in the lower housing part 51 and will be described below.

A piezo membrane pump 53 is seated in a recess 54 of the housing part 51 and actuates a pump piston 56, which is guided displaceably in the housing part 51, extends into a hydraulic chamber 55 and can be displaced by the pump 53 in the direction of arrow P and in the direction opposite the direction indicated by arrow P, as a result of which the volume of the hydraulic chamber 55 can be changed. If the pump piston 56 is moved in the direction of arrow P, the volume of the hydraulic chamber 55 decreases, so that a hydraulic fluid 57 introduced into this chamber flows into the hydraulic chamber 37 through a hydraulic channel 58. As a result, the piston 33 is displaced in the direction of arrow Q, which brings about a deformation of the bearing shell 4 and hence an increase in the mechanical stress exerted by the bearing shell 4 on the joint ball 1. A valve 59, with which the hydraulic fluid 57 can be prevented from flowing back from the hydraulic chamber 37 into the hydraulic chamber 55, is provided in the hydraulic chamber 55. Furthermore, a compensating tank 60 filled with the hydraulic fluid 57 is arranged in a recess 61 of the housing part 51 and is closed by an elastic cover 82, which is secured on the housing 5 by means of a cover 62.

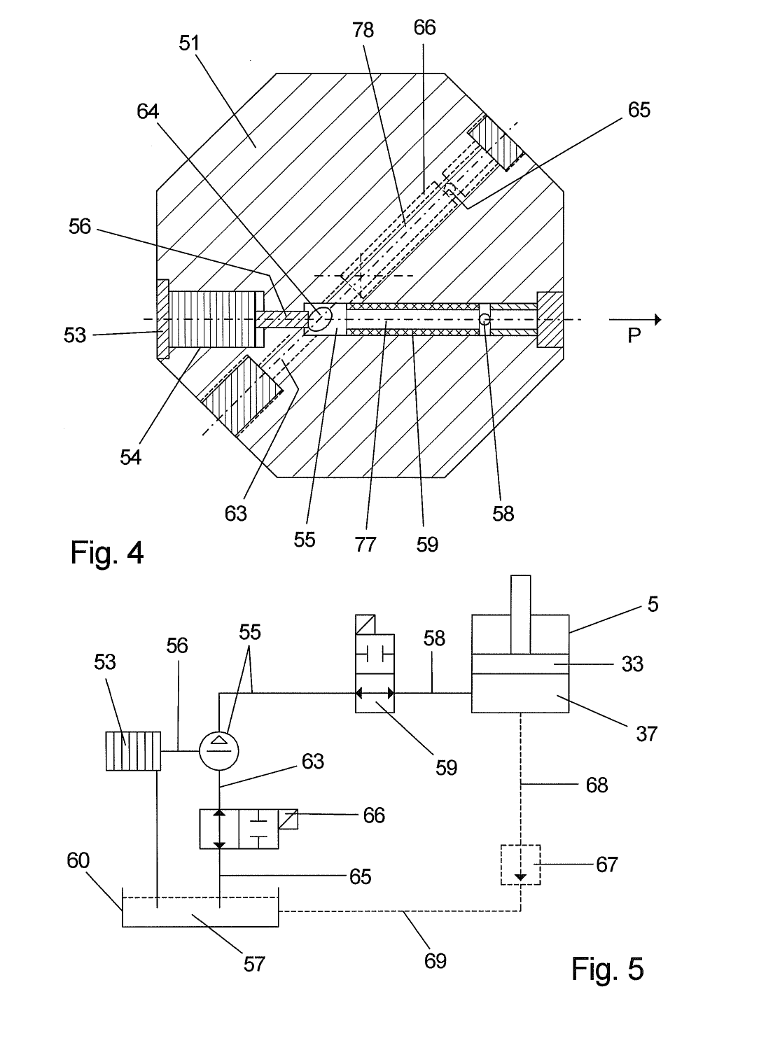

FIG. 4 shows a section of the sixth embodiment along section line 79 from FIG. 3, wherein a hydraulic chamber 63 located behind the hydraulic chamber 55 is indicated by broken lines. The hydraulic chamber 63 is in connection with the hydraulic chamber 55 via an opening 64 and is connected to the compensating tank 60 via a hydraulic line 65. Furthermore, the hydraulic chamber 63 has a valve 66, which can prevent the hydraulic fluid 57 from flowing out of the hydraulic chamber 55 through the opening 64, through the hydraulic chamber 63 and through the hydraulic line 65 and into the compensating chamber 60 during motion of the pump piston 56 in the direction of arrow P. The two valves 59 and 66 may be designed as nonreturn valves, and an additional valve 67 (see FIG. 5), designed especially as a miniature solenoid valve and additional hydraulic paths 68, 69 (see FIG. 5) may be provided, so that pressurized or hydraulic fluid can be drawn off from the hydraulic chamber 37. However, it is also possible, as an alternative, to use as the hydraulic fluid 57 an electrorheological or magnetorheological fluid, whose viscosity can be controlled by means of an electric or magnetic field. The valves 59 and 66 can be designed in this case as so-called “rheo valves” and generate a magnetic or electric field, which passes through channels 77 and 78, so that the flow of hydraulic fluid through the channels 77 and/or 78 is possible or prevented depending on the intensity of the field. The additional valve 67 with the lines 68, 69 for releasing the pressure from the hydraulic chamber 37 is not necessary in this case.

FIG. 5 shows a schematic view of the hydraulic adjusting device or the hydraulic circuit according to the sixth embodiment, wherein the valves 59 and 66 are preferably designed as rheo valves, which enable the flow of hydraulic fluid 57 in both directions. In case the valves 59 and 66 form only nonreturn valves, the additional valve 67 as well as the two additional lines 68, 69 are provided and indicated by broken lines. The additional valve 67 is connected to the hydraulic chamber 37 via line 68 and to the compensating tank 60 via line 69.

According to a sixth embodiment, it is proposed that the pressure generation be integrated directly in the ball and socket joint housing 5. This is possible because there are practically no or only small volumes delivered (max. 1 cm³ plus the compressibility of the pressurized medium) and the necessary pressures are relatively small (<100 bar, averaging max. 50 bar). Instead of arranging the electric motor, the pump, the valve and the pipes on the outside, a piezo membrane installed in the lower housing part 51 or in the cover of the ball and socket joint 20 is used as the pump 53. This is set to vibrate by an electric voltage and pumps the hydraulic fluid present in front of the piston 56 to and fro. To bring about the pumping effect, the pump chamber has two connection channels or connections; one to the compensating tank 60 and the other to the hydraulic chamber 37 at the piston 33 below the bearing shell 4. Nonreturn valves 59, 66, which make possible suction and pumping during each stroke of the piston 56 without pushing the fluid 57 only to and fro, may be provided in these two connections. A miniature solenoid valve 67 can be connected to the hydraulic chamber 37 in order to draw off the pressure from this chamber 37. However, it is also possible to use, as an alternative, a rheological fluid as a pressurized medium 57, in which case the two valves 59 and 66 are designed as rheo valves. The connections to the compensating tank 60 and to the hydraulic chamber 37 can be controlled in this case via electric or magnetic fields, which alternatingly block or release the flow of the hydraulic fluid 57 in the cycle of or synchronously with the vibrations of the piezo membrane. The connections have very small diameters (1-3 mm) and are provided in the lower housing part 51. This pressure is automatically admitted to the piston 33, whose diameter is somewhat larger than the diameter of the joint ball 1. However, since the area of the piston 33 is approx. 100 times larger than the area of the piston 56, the pressing forces are also approx. 100 times stronger than the axial forces, which can still be reached by the piezo effect. The stroke of the piston 33 is very small (for example, max. 0.3 mm), but is nevertheless sufficient to enhance the force exerted by the bearing shell 4 on the joint ball 1 to the extent that the joint ball 1 will be immobile. In the case of a rheological fluid as the hydraulic fluid 57 and if rheo valves 59, 66 are provided, no additional valve 67 is needed for drawing off the pressure from the chamber 37, because the two channels 77 and 78 can be released for the passage of hydraulic fluid 57 by reducing or eliminating, for example, the current that flows through the rheo valves 59, 66 and is used to build up the magnetic fields.

The torque of the ball and socket joint 20 can be regulated infinitely, especially very sensitively in each position due to the integration of the piezo pump 53 in the ball and socket joint housing 5 and the use of rheological fluids as the hydraulic fluid 57. The vibration frequencies of the piezo pump 53 can be selected to be very high, and synchronization between the piezo membrane and the two Theological valves 59, 66 is possible without problems. The efficiency is very high and the run times are very short because of the high frequency. In addition, the piezo membrane can be used to measure the pressure and employed, for example, as a pressure sensor in a control circuit.

FIG. 6 shows a seventh embodiment of the joint according to the present invention, which is a variant of the fifth embodiment, wherein the hydraulic adjusting device is integrated in the ball and socket joint housing 5. The seventh embodiment is, in particular, an alternative to the sixth embodiment, wherein identical or similar features are designated by the same reference numbers as in the fifth and sixth embodiments.

The housing 5 has an upper housing part 50 and a lower housing part 51, which is fixed to the upper housing part 50. A hydraulic chamber 55, which is connected to the hydraulic chamber 37 below the piston 33 via a hydraulic line 58, is formed in the lower housing part 51. A primary piston 56 is guided displaceably in the hydraulic chamber 55 in the direction of arrow P and in the direction opposite arrow P, so that the volume of the hydraulic chamber 55 can be varied by the motion of the primary piston 56. A hydraulic fluid 57, which flows into the hydraulic chamber 37 through the hydraulic line 58 during the motion of the primary piston 56 in the direction of arrow P and lifts the piston 33 in the direction of arrow Q, is provided in the hydraulic chamber 55. The primary piston 56 has an annular groove 70, in which a sealing ring 71 is seated, which seals the primary piston 56 against the inner wall of the hydraulic chamber 55. The primary piston 56 is connected via a gear mechanism 72 to an electric motor 73, which is fixed to the lower housing part 51. The motor 73 is designed especially as an electric stepping motor, which can push a linear spindle 75, which is connected to the primary piston 56. Furthermore, a compensating tank 60, which is filled with hydraulic fluid 57, is closed with an elastic cover 82 and is secured on the lower housing part 51 by means of a bracket 62, is provided in a recess 61 of the lower housing part 51. The compensating tank 60 is connected via a channel 74 to the hydraulic chamber 55, and the channel 74 can be opened or closed depending on the position of the primary piston 56. The channel 74 forms a hydraulic connection between the compensating tank 60 and the volume of the hydraulic chamber 55 filled with hydraulic fluid 57 in the opened state. This hydraulic connection is interrupted in the closed state of the channel 74.

As in the sixth embodiment, the pressure generation is directly integrated in the ball and socket joint housing 5 according to the seventh embodiment, which can be embodied for the same reasons as in the sixth embodiment. In particular, it is possible to provide a small stepping motor 73 with integrated linear spindle 75, which [motor] can push the primary piston 56 to and fro in the direction of arrow P and in the direction opposite arrow P. Such a stepping motor 73 with linear spindle 75 is available as a commercial product at low cost.

The primary piston 56 preferably has a small diameter of 3-5 mm, which is seated in the hydraulic chamber or hole 55 in the lower housing part 51. The primary piston 56 has, in particular, a stroke of 15-30 mm. The hole 55 is connected via the channel 58 to the chamber 37 and hence to the piston 33. The same pressure is automatically admitted to the secondary piston 33, whose diameter is somewhat larger than the diameter of the joint ball 1. However, since the area of the secondary piston is approx. 100 times larger than the area of the primary piston 56, approx. 100 times stronger pressing forces are generated as well. Even though the stroke of the secondary piston 33 is approx. 100 times smaller than the stroke of the primary piston 56, this is still sufficient to increase the torque or the moment of friction of the ball and socket joint 20 until immobility is achieved. No valve is needed to lower the pressure in the hydraulic chamber 37. The lowering of the pressure is achieved by the stepping motor 73 being rotated backwards, which leads to the primary piston 56 moving in the direction opposite arrow P. The compensating chamber 60 is included in the hydraulic circuit in the withdrawn position of the primary piston 56 only and is used only to compensate losses due to leakage and temperature-dependent pressure variations. The withdrawn position is defined here as a position in which the primary piston 56 is displaced in the direction opposite arrow P to the extent that a hydraulic connection is formed via the channel 74 between the compensating tank 60 and the volume of the hydraulic chamber 55.

Compared to the fifth and sixth embodiments, valves and pressure sensors can be eliminated. Furthermore, a reduction of the necessary lines and screw connections can be achieved. The torque of the ball and socket joint 20 can be regulated infinitely, very sensitively in each position. The losses of efficiency are very small, even though a 100-fold boost can be easily attained. The integration of the hydraulic circuit in the ball and socket joint 20 reduces the necessary quantity of pressurized medium to a minimum, especially to the necessary compensation of the compressibility of the pressurized medium.

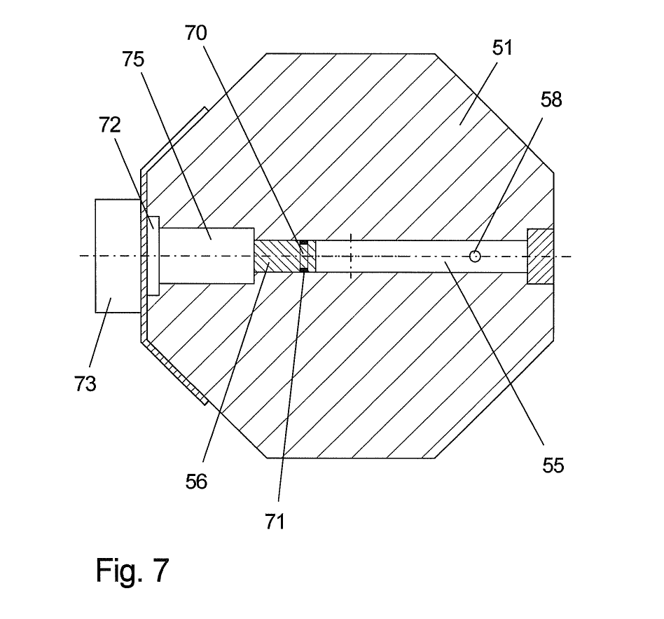

FIG. 7 shows a sectional view of the embodiment according to FIG. 6 along section line 79, from which the simplified design compared to the sixth embodiment becomes clear.

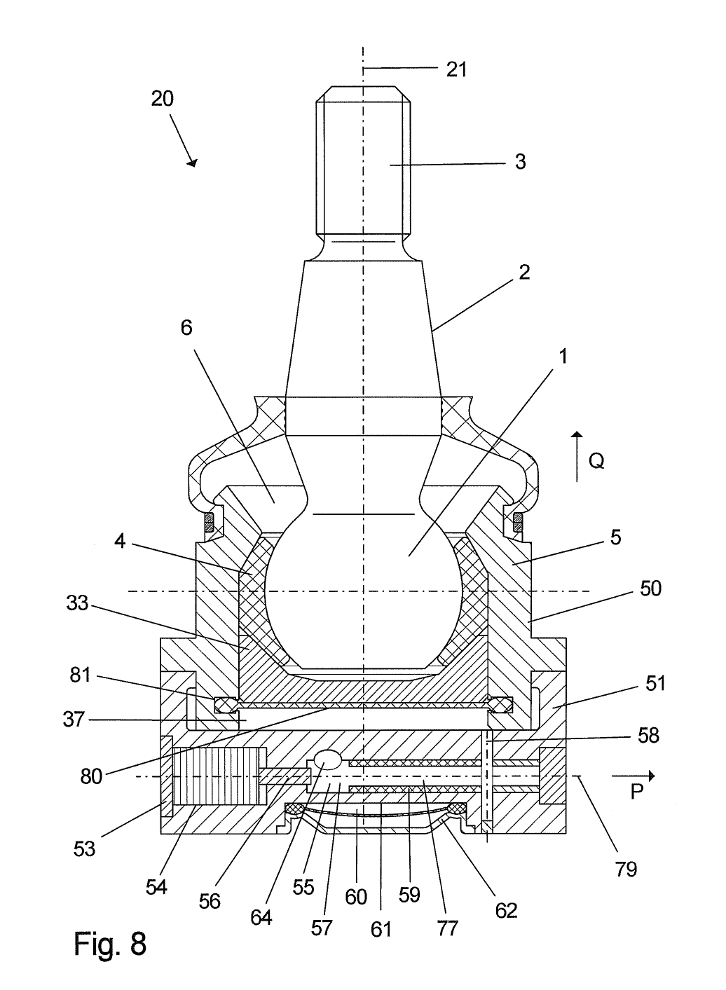

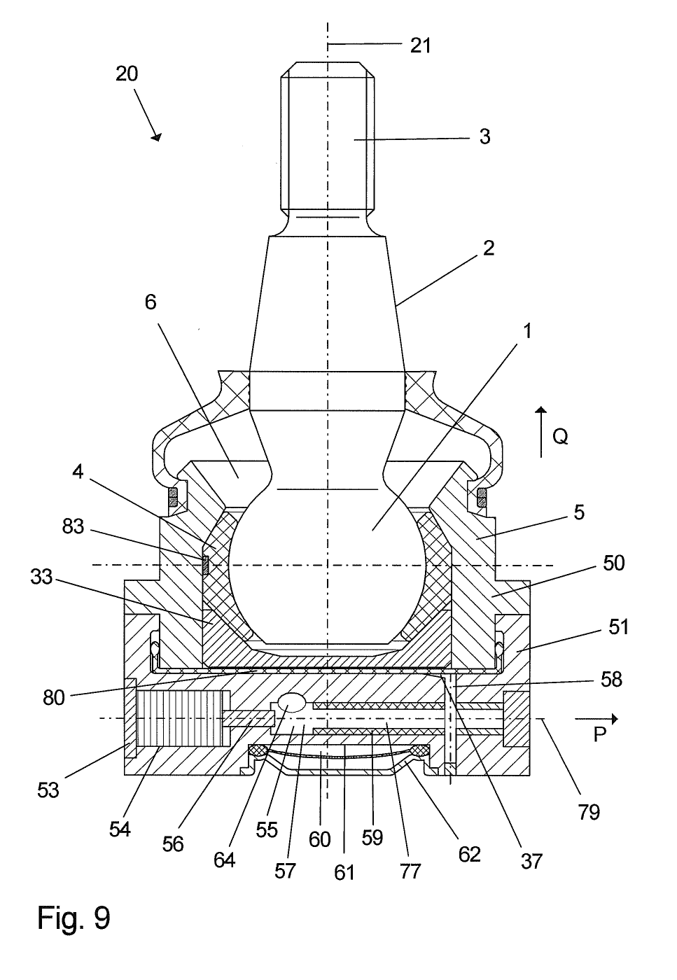

FIGS. 8 and 9 show modifications of the embodiment according to FIG. 3, wherein identical and similar features are designated by the same reference numbers as in the sixth embodiment. An elastic membrane 80 is provided between the piston 33 arranged in the upper housing part 50 and the lower housing part 51 or housing bottom, so that the hydraulic chamber 37, which is accessible via the hydraulic channel 58, is formed between the membrane 80 and the housing bottom 51. If hydraulic fluid 57 is fed to the hydraulic chamber 37 via the hydraulic channel 58, the membrane 80 expands and presses the piston 33 in the direction of arrow Q. The elastic membrane 80 is preferably fixed sealingly on the housing 5, so that the sealing ring 36 visible in FIG. 3, which is used to seal the piston 33 against the housing inner wall 13, can be eliminated in this modification. Furthermore, the membrane 80 may extend up to the area between the outer circumferential surface 34 of the piston 33 and the housing inner wall 13.

According to the first modification shown in FIG. 8, the membrane 80 is fastened in an annular groove 81 provided in the inner wall 13 of the housing 5. As an alternative, the membrane 80 may, however, also be fixed, especially clamped, between the upper housing part 50 and the lower housing part 51, which is shown in FIG. 9.

Furthermore, a force sensor 83, which sends a signal representing the current mechanical stress exerted by the bearing shell 4 on the joint ball 1, is arranged according to FIG. 9 between the bearing shell 4 and the housing 5. The force sensor 83 thus opens up a possibility of embodying a control for the hydraulic adjusting device. As an alternative, the force sensor may also be designed as a pressure sensor and integrated, for example, in the hydraulic circuit. The pressure sensor is seated for this purpose, for example, in the hydraulic chamber 55 or is formed by the piezo membrane of the pump 53.

Even though these modifications were explained as variants of the sixth embodiment, it is possible to provide an elastic membrane between the piston 33 and the housing bottom 32 or 31 in the other embodiments, so that the sealing ring 36 can be eliminated there as well. Furthermore, the use of a force or pressure sensor is possible in all embodiments.

While specific embodiments of the invention have been shown and described in detail to illustrate the application of the principles of the invention, it will be understood that the invention may be embodied otherwise without departing from such principles.

1. A joint for a motor vehicle, the joint comprising:
a housing,
a bearing shell arranged in said housing;
a bearing journal, which has a bearing area and a pivot area and is mounted pivotably and/or rotatably in said bearing shell with said bearing area; and
a tensioning means arranged in said housing and designed as a solid body, and by which a mechanical stress exerted by said bearing shell on said bearing area can be changed, said bearing shell being springy at least in some areas and being deformable by said tensioning means in a springy manner.

2. A joint in accordance with claim 1, wherein said tensioning means is arranged outside said bearing shell and acts on a first outer surface area of said bearing shell.

3. A joint in accordance with claim 2, wherein said first outer surface area has a truncated cone-shaped design.

4. A joint in accordance with claim 2, wherein said tensioning means has at least one truncated cone-shaped surface area and acts via same on said first outer surface area.

5. A joint in accordance with claim 3, wherein said bearing shell is provided with a second truncated cone-shaped outer surface area, wherein said housing has an inner wall with a truncated cone-shaped inner wall area, with which said second outer surface area is in contact.

6. A joint in accordance with claim 5, wherein said two truncated cone-shaped outer surface areas of said bearing shell taper with increasing distance from each other.

7. A joint in accordance with claim 5, wherein said bearing area is arranged at least partially between said two outer surface areas of said bearing shell.

8. A joint in accordance with claim 1, wherein said tensioning means has carbon nanotubes or a piezoelectric, electrostrictive or magnetostrictive material.

9. A joint in accordance with claim 1, wherein said tensioning means is a piston mounted displaceably in said housing.

10. A joint in accordance with claim 9, wherein a hydraulic adjusting device, by which said piston can be displaced in said housing, is arranged at least partially in said housing.

11. A joint in accordance with claim 10, wherein said hydraulic adjusting device has an electrorheological or magnetorheological hydraulic fluid and at least one said hydraulic line, through which an electric or magnetic field flows.

12. A joint in accordance with claim 10, wherein said hydraulic adjusting device has a hydraulic pump arranged on or in said housing.

13. A joint in accordance with claim 10, wherein said hydraulic adjusting device has an electric motor arranged on or in said housing and a primary piston, which is displaceable by said motor.

14. A joint in accordance with claim 10, wherein an elastic membrane (80) is arranged between said piston and said housing.

15. A joint in accordance with claim 10 14, wherein said hydraulic adjusting device has a compensating tank integrated in said housing.

16. A joint in accordance with claim 15, wherein said compensating tank has an elastic cover.

17. A joint in accordance with claim 10 16, wherein said hydraulic adjusting device is completely integrated in the joint.

18. A joint in accordance with claim 1, wherein the joint is a ball and socket joint and the joint area is a joint ball.

19. A joint in accordance with claim 1, wherein said bearing shell has a one-part design.

20. A joint in accordance with claim 1, wherein a pressure sensor and/or a force sensor is provided in said housing.
